(19) United States
(12) Patent Application Publication
(10) Pub. No.: US 2016/0272163 A1
(43) Pub. Date: Sep. 22, 2016

(54) VEHICLE CAMERA WITH LENS WASHER SYSTEM

(71) Applicant: MAGNA ELECTRONICS INC., Auburn Hills, MI (US)

(72) Inventors: Rene Dreiocker, Rochester Hills, MI (US); Jamie A. Mleczko, Washington, MI (US); Steven V. Byrne, Goodrich, MI (US); Yuesheng Lu, Farmington Hills, MI (US); Jonathan D. Conger, Berkley, MI (US)

(21) Appl. No.: 15/072,637

(22) Filed: Mar. 17, 2016

Related U.S. Application Data
(60) Provisional application No. 62/189,963, filed on Jul. 8, 2015.
(60) Provisional application No. 62/158,838, filed on May 8, 2015.
(60) Provisional application No. 62/134,062, filed on Mar. 17, 2015.

(51) Int. Cl. B60S 1/56; H04N 5/225; H04N 5/217; G02B 27/00; B60R 11/04; B60S 1/48

(52) U.S. Cl. CPC B60S 1/56; B60R 11/04; B60S 1/48; H04N 5/2171; G02B 27/0006; H04N 5/2252; B60R 2011/004

(57) ABSTRACT

A vision system of a vehicle includes a camera configured to be disposed at an exterior portion of a vehicle so as to have a field of view exterior of the vehicle. The camera includes a lens. A washer includes a connector and fluid passageway. The washer is configured to be detachably attached at the camera when the camera is disposed at the exterior portion of the vehicle. When attached at the camera, the connector is configured for connection to a washer system of a vehicle such that, when the vehicle washer system is actuated, pressurized fluid flows through the fluid passageway and onto the lens.

### CROSS REFERENCE TO RELATED APPLICATIONS

The present application claims the filing benefits of U.S. provisional applications, Ser. No. 62/189,963, filed Jul. 8, 2015; Ser. No. 62/158,838, filed May 8, 2015 and Ser. No. 62/134,062, filed Mar. 17, 2015, which are hereby incorporated herein by reference in their entireties.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

Obscuring view by mud, salt or dust is becoming an increasing issue for vehicle cameras as their ability to determine and recognize objects can be limited or interrupted. Vehicle manufacturers have recently started to add washer nozzles mounted at the vehicle in close proximity to the camera lens. These washer nozzles spray a high pressure stream of water onto the lens when activated, thus cleaning the lens within a short amount of time. Typically, the camera washer is integrated into the existing windshield washer system and is activated through the same pump.

There are typically two types of nozzles provided at a vehicle, stationary and retractable. Stationary nozzles are mounted at the vehicle near the camera and stand proud of the lens, which limits positioning (such as below or above or at 6 or 12 o'clock) to prevent cropping the wide angle lateral field of view of the camera. For horizontal nozzle positioning (3 or 9 o'clock), a retractable nozzle type has been introduced. The retractable nozzle is mounted at the vehicle near the camera so as to be positioned sub-flush to the camera lens, extending or moving forward only when activated.

Both systems are aids that have to be installed in addition to the camera, thereby adding cost to the assembly process at the system suppliers. Both systems take up packaging room, thus reducing the available area of engine air flow through the front grille (for a forward viewing camera). Both systems are seen as an interference to the overall scheme of the vehicle by studio designers.

### SUMMARY OF THE INVENTION

The present invention provides a vision system or imaging system for a vehicle that utilizes one or more cameras (preferably one or more CMOS cameras) to capture image data representative of images exterior of the vehicle, and provides a lens washer integrated into the camera housing to provide pressurized fluid at the camera lens. The camera may be mounted or disposed at an exterior structure of the vehicle, such as, for example, a vehicle panel, grill, bumper, fascia, light bar, center high mounted stop lamp (CHMSL) or the like, with its lens viewing exterior of the vehicle. The lens washer may be molded with the housing portion and lens barrel of the camera and provides a fluid passageway along the housing and lens barrel and a nozzle that sprays pressurized fluid onto the lens to remove dirt or debris from the lens. Optionally, the lens washer may comprise a separate element that snap attaches at the lens barrel and/or at the camera housing such that, when snap attached, the nozzle end is directed at the outer surface of the lens of the camera.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras in accordance with the present invention;

FIG. 2 is a perspective view of the camera and integrated washer of the present invention, shown with the integrated washer along the lens barrel of the camera housing;

FIG. 3 is a sectional view of the camera of FIG. 2;

FIG. 4 is an enlarged perspective view of the lens and nozzle of the integrated washer of the camera of FIG. 2;

FIG. 5 is a rear perspective view of the camera of FIG. 2;

FIG. 6 is a perspective view of another camera and washer assembly of the present invention;

FIG. 7 is a side view and partial sectional view of the washer body and cover of the camera and washer assembly of FIG. 6;

FIG. 8 is a perspective view of a portion of the washer body of FIG. 7;

FIG. 9 is a perspective view of a cover for the washer body of FIGS. 7 and 8;

FIG. 10 is a perspective view of another camera and washer assembly of the present invention;

FIG. 11 is another perspective view of the camera and washer assembly of FIG. 10;

FIG. 12 is a perspective view of the lens end of the camera and washer assembly of

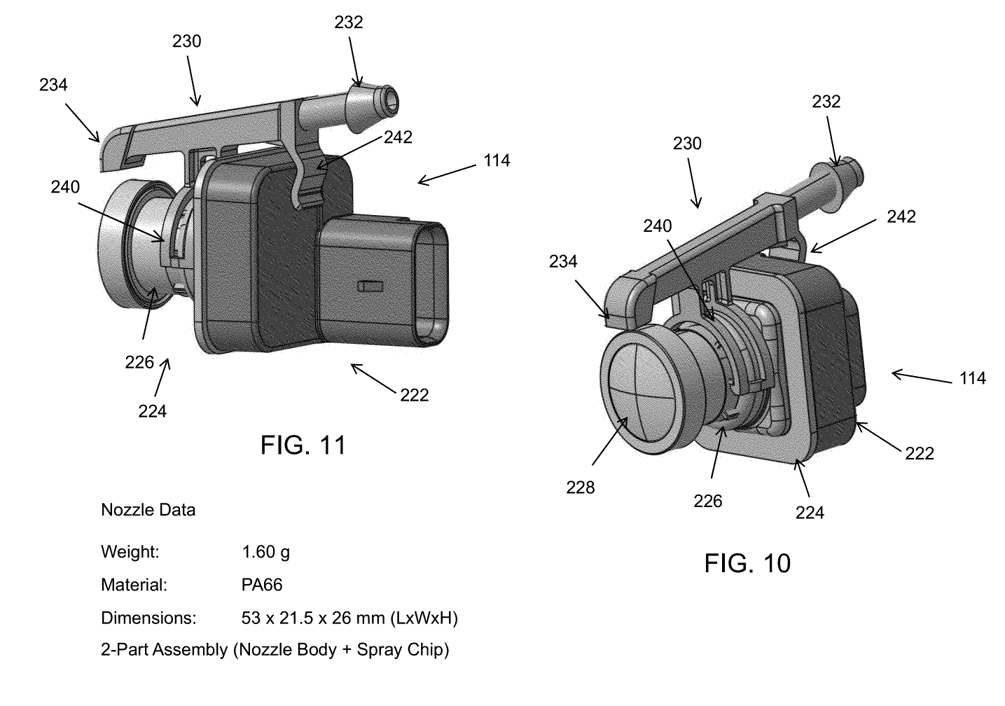

FIGS. 10 and 11;

FIG. 13 is a perspective view of the washer that clips onto the camera body to form the camera and washer assembly of FIGS. 10 and 11;

FIG. 14 is a perspective view of a rear camera housing of the present invention, shown with cooling fluid channels for cooling the camera in accordance with the present invention; and

FIG. 15 is a perspective view of a front camera housing with fluid channels for connecting with the cooling fluid channels of the rear camera housing of FIG. 14 for washing a lens of the camera in accordance with the present invention.

### DESCRIPTION OF THE PREFERRED EMBODIMENTS

A vehicle vision system and/or driver assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide a top down or bird's eye or surround view display and may provide a displayed image that is representative of the subject vehicle, and optionally with the displayed image being customized to at least partially correspond to the actual subject vehicle.

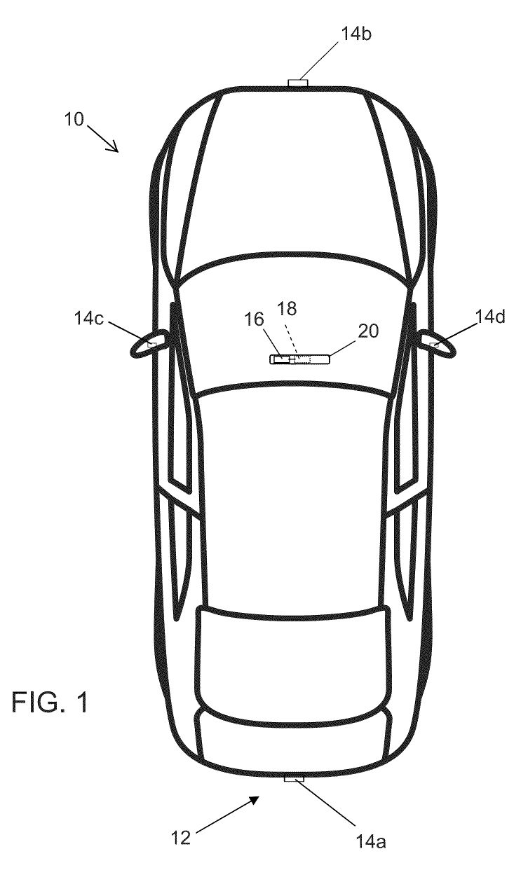

Referring now to the drawings and the illustrative embodiments depicted therein, a vehicle 10 includes an imaging system or vision system 12 that includes at least one exterior facing imaging sensor or camera, such as a rearward facing imaging sensor or camera 14a (and the system may optionally include multiple exterior facing imaging sensors or cameras, such as a forwardly facing camera 14b at the front (or at the windshield) of the vehicle, and a sidewardly/rearwardly facing camera 14c, 14d at respective sides of the vehicle), which captures images exterior of the vehicle, with the camera having a lens for focusing images at or onto an imaging array or imaging plane or imager of the camera (FIG. 1). The vision system 12 includes a control or electronic control unit (ECU) or processor 18 that is operable to process image data captured by the cameras and may provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

The cameras include a housing and imager and a lens that is oriented such that the camera views exterior of the vehicle. Such automotive camera lenses are susceptible to dirt or debris collecting at the lens of the camera. This is particularly an issue for cameras mounted at the front of a vehicle, such as at a front bumper or grill or fascia of the vehicle.

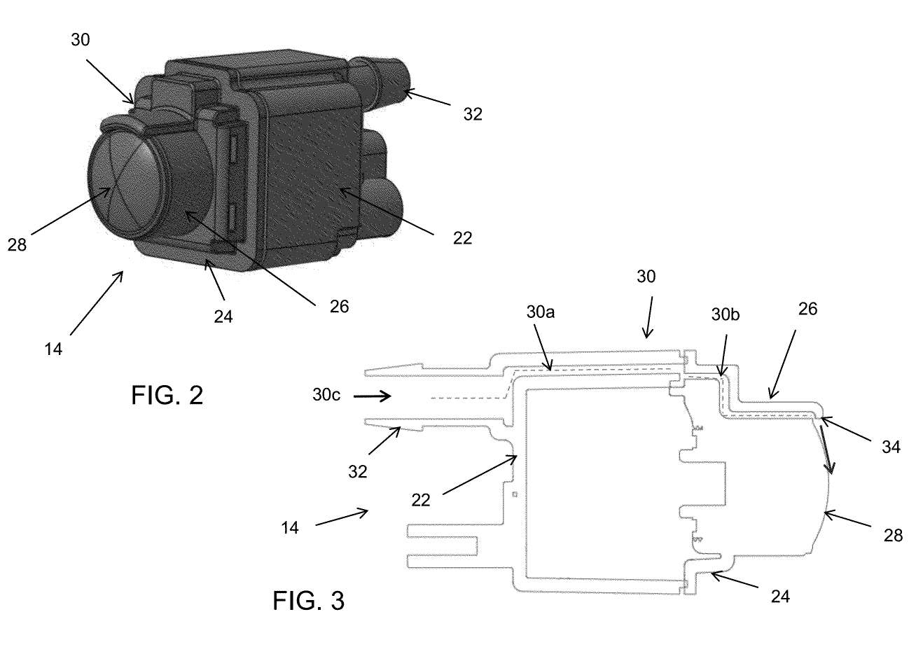

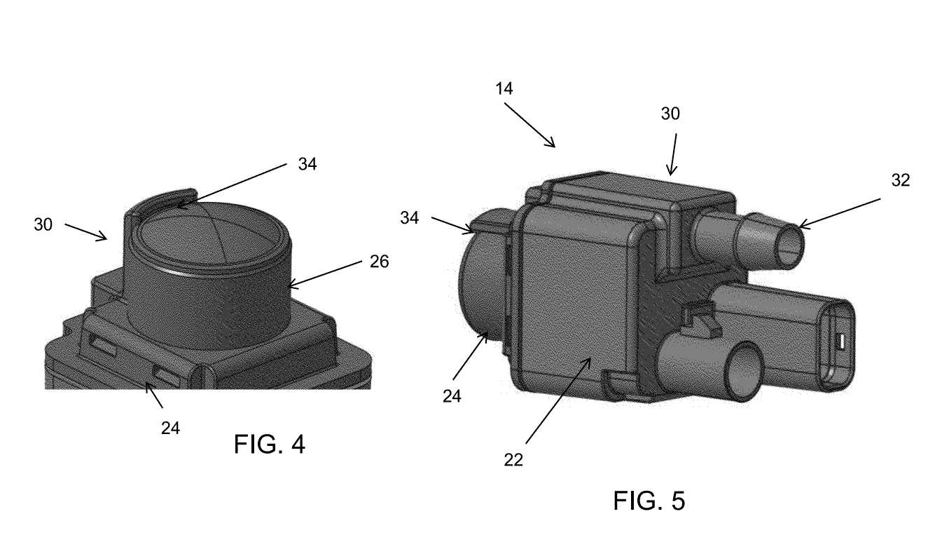

As shown in FIGS. 2-5, a camera 14 (such as the front or forward viewing camera or a side or rear camera) includes a rear housing portion 22 and a front housing portion 24 having a lens barrel 26 that supports a lens 28. The rear housing portion 22 and the front housing portion 24 are formed to provide an integrated washer 30 having respective portions 30a, 30b of a fluid passageway or channel through and along which pressurized fluid flows. The rear housing portion 22 includes a fluid connector 32 that connects to a washer system of the vehicle, such as to a hose or pipe or tube of a fluid washer system of the vehicle to receive pressurized fluid from the washer system (when the washer system is actuated), whereby the pressurized fluid flows into and along the passageway or channel portions 30a, 30b to a nozzle 34 at the lens 28. In the illustrated embodiment, the nozzle 34 is formed or disposed above the lens (such as at the 12 o'clock position) and is configured to spray fluid down along the outer surface of the lens (such as best shown in FIG. 3).

The cleaning fluid entrance 30c is realized through the hose connector 32 which is molded into the camera rear cover or housing portion 22. The cleaning fluid then is transported (via provided pressure by the pump) through the fluid channel 30a of the rear cover 22 and the fluid channel 30b of the front cover 24 and lens holder 26. The top of the lens holder 26 has an opening or nozzle 34 to allow the cleaning fluid to exit the channel 30b and flow onto and over the camera lens 28 taking off any debris, dust, snow or the like. The opening or nozzle 34 is designed in a way that it provides a wide enough spray pattern of the fluid to cover the camera lens.

The present invention thus provides a camera integrated channel to transport cleaning fluid from the hose connector on the back side of the camera through the camera rear cover or housing portion and front cover or housing portion and lens holder up to the camera lens. As result of the integration of the fluid channel and nozzle into the camera, no additional components for this cleaning system are needed, thus providing a compact, space saving camera/washer unit.

The washer system of the present invention does not require any assembly in addition to the assembly of the camera components itself. The washer unit is readily connected to the wiper fluid system via a fluid hose and is powered through the same pump (although optionally it may be powered or controlled via a separate pump or system if desired). The connector and rear passageway portion are integrally formed with the rear cover or housing portion (such as via an injection molding process), while the front passageway portion and nozzle or outlet are integrally formed with the front cover or housing portion or lens holder (such as via an injection molding process). When the front cover or lens holder is attached at the rear cover or housing portion, the passageways are aligned to form a continuous fluid passageway from the hose connector to the nozzle or outlet, whereby fluid provided at the connector (via actuation of a pump of a washer system of the vehicle) flows through the passageway or channel to the nozzle or outlet and onto the outer surface of the lens.

In addition to cleaning the camera lens, the integrated fluid channel functions as a heat sink, improving the heat dissipation through the camera housing.

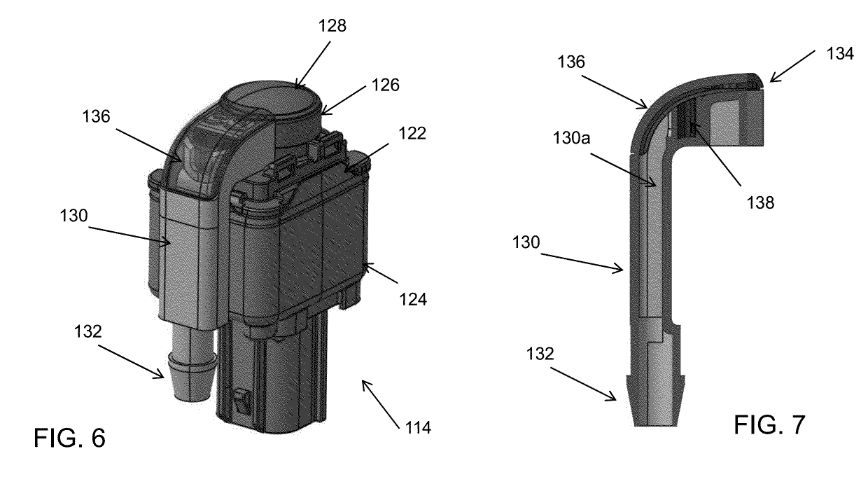

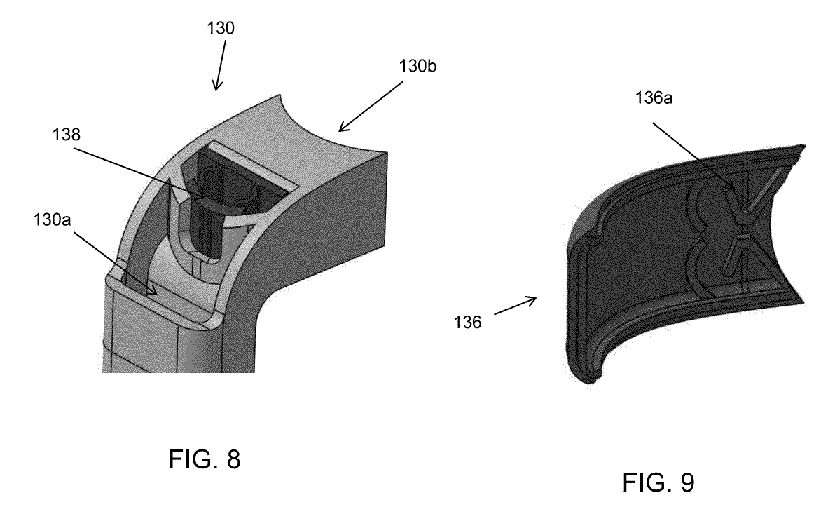

Optionally, and with reference to FIGS. 6-9, a camera 114 (such as the front or forward viewing camera or a side or rear camera) includes a rear housing portion 122 and a front housing portion 124 having a lens barrel 126 that supports a lens 128. A washer body 130 is disposed along and attaches to the camera housing portions 122, 124 and is configured to provide a fluid passageway or channel through and along which pressurized fluid flows. The washer body 130 includes a flow channel 130a extending between a hose connector end 132 and a nozzle end 134. The nozzle end 134 is at a curved or arcuate surface 130b that is configured to generally correspond with or mate with the cylindrical outer surface of the lens barrel 126 of the camera 114, when the washer body 130 is attached at the camera (such as via a snap fit attachment or the like).

The camera 114 and washer body 130 provide a washer nozzle with integrated (molded-in) pressure channels and an integrated valve. The valve body includes a cover piece 136 that is removably attached at the valve body. The cover piece 136 includes a molded-in pressure channel 136a that is configured to provide the desired or selected flow characteristics to the water or fluid flowing through the flow channel 130a of the washer body.

Typically, the distinct spray pattern of a nozzle is created by a separate piece (chip) which has to be assembled into the nozzle body. The present invention has the chip-typical channel or channels directly molded into the cover piece of the washer body or nozzle.

Optionally, and as shown in FIGS. 6 and 7, the washer body 130 includes a valve 138 disposed in the flow channel to prevent back flow of the water or fluid when the pressure is not applied. Typically, this type of valve is a separate multi-piece item that is installed into the water circuit. In accordance with the present invention, such a multi-piece valve is replaced by a single piece that is installed directly into the washer nozzle. The installation of a separate valve into the water circuit would thus not be needed with the washer body of the present invention. The valve 138 may be removably disposed in the washer and may be removed or replaced when the cover element 136 is removed from the washer body.

Optionally, and with reference to FIGS. 10-13, a camera 214 (such as the front or forward viewing camera or a side or rear camera) includes a rear housing portion 222 and a front housing portion 224 having a lens barrel 226 that supports a lens 228. A washer body 230 is disposed along and attaches to the camera housing portions 222, 224 and is configured to provide a fluid passageway or channel through and along which pressurized fluid flows, such as in a similar manner as discussed above. The washer body 230 includes a flow channel or passageway extending between a hose connector end 232 and a nozzle end 234 (and may include a spray chip or the like such as discussed above press fit into the nozzle body or nozzle end of washer). The washer body 230 also includes a clip element 240 that is configured to snap attach at the lens barrel 226 and includes a spring element or tab 242 that is configured to engage the rear housing portion 222 to retain the washer body 230 at the camera 214.

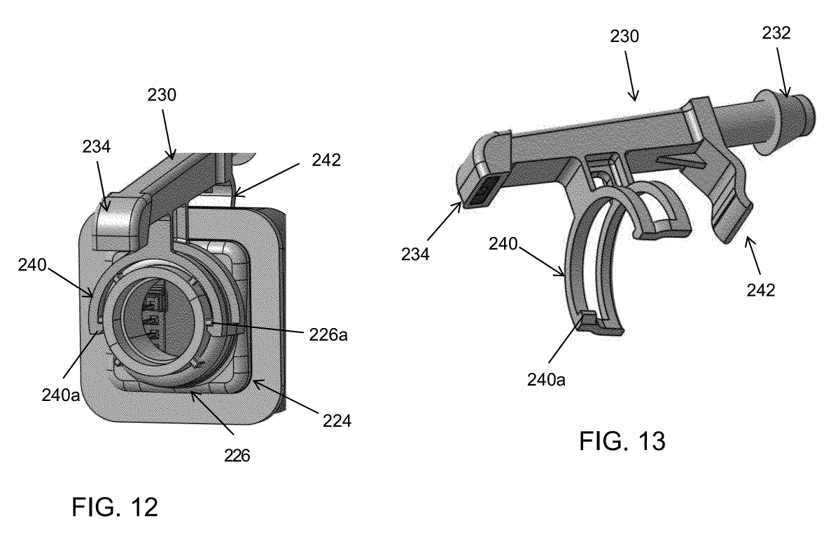

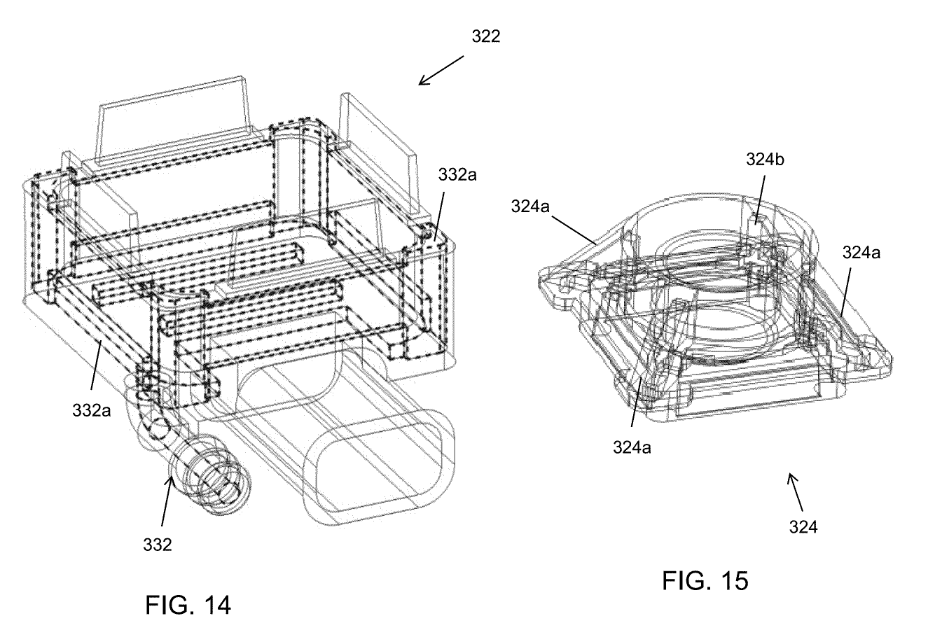

As can be seen in FIGS. 10-13, the washer body 230 is configured to extend along the camera housing and the clip or clip ring 240 is configured to engage the lens barrel 226 and snap thereto. In the illustrated embodiment (and as best shown in FIG. 12), the clip ring comprises partial circular arms or tabs that partially receive the lens barrel in and that include snap tabs or features 240a that engage respective ribs or tabs 226a on the lens barrel 226, thereby snap attaching the washer body 230 at the lens barrel 226 and positions the nozzle end 234 at the lens center while limiting or substantially precluding rotation of the washer body relative to the lens barrel. As can be seen in FIG. 12, the clip ring bottoms out on the upper surface of the lens barrel when the snap features snap attach at the lens barrel ribs, thereby positioning the nozzle at the appropriate or selected axial distance or height from the lens or lens axis.

As best shown in FIGS. 11 and 13, the spring element or tab or finger 242 of washer 230 is configured to flex as it engages the rear surface of the rear housing portion 222 when the snap ring 240 snap attaches at the lens barrel 226. The spring element 242 provides pressure against the rear housing portion or rear cover 222 and allows the washer body 230 to float relative to the rear housing portion 222. The washer body thus, when snap attached at the lens barrel is positioned relative to the camera such that the nozzle is at a selected or desired or appropriate location relative to the lens and/or principal axis of the lens and/or outer surface of the lens, such that the nozzle, when the washer is operated, sprays fluid at the outer surface of the lens to clean the lens. The spring finger pushes against the rear cover or housing portion while allowing the rear cover to float and rotate planar to the longitudinal axis of the camera. The snap ring or clip feature attaches to a rigid part of the lens barrel and engages ribs of the lens barrel to limit or substantially preclude rotation of the washer body about the lens barrel and to substantially fix the nozzle in a desired or selected axial direction along the camera and lens barrel.

Thus, the present invention provides a washer system that has a fluid passageway and connector and nozzle integrated into the housing portions and lens holder of an exterior camera of a vehicle (such as a forward viewing camera mounted at a front exterior portion of the vehicle). The integrated washer system provides or sprays washing fluid at the lens to clean the lens. The washer system may be automatically operable to spray the lens when image processing of captured image data determines that the lens is dirty, or may be manually actuated when captured images displayed for viewing by the driver of the vehicle show dirt or debris at the lens or may be manually operated in conjunction with the windshield wiper washer system. The integrated camera and washer system may utilize aspects of the camera systems described in U.S. patent application Ser. No. 15/062,526, filed Mar. 7, 2016 (Attorney Docket MAG04 P-2709), which is hereby incorporated herein by reference in its entirety.

Optionally, the camera or vision system of the present invention may include a temperature sensor at the camera to determine a temperature of the camera, such as during operation of the camera or when the camera is exposed to increased temperatures. The system may monitor the temperature at the camera and, responsive to the temperature being above a threshold level, the system may activate the washer at the camera to flow fluid through cooling channels of the camera housing to reduce the temperature of the camera. The flowing fluid may also spray onto the camera and the lens to cool the camera and clean the lens of the camera. Thus, the system may actively cool the camera thermally via the washer system whereby a temperature monitoring circuit in the camera triggers the washer system.

For example, and as shown in FIGS. 14 and 15, a camera assembly of the present invention includes a rear camera housing 322 (FIG. 14) and a front camera housing 324 (FIG. 15). The rear camera housing 322 includes a fluid input port 332, which is connectable to a pressurized fluid supply line or hose or tube of the vehicle when the camera is disposed at the vehicle. When the washer or cooling function is activated, the fluid enters the inlet port 332 and flows through at least one and preferably more than one channel 332a through the rear housing (such as a plurality of channels or cavities established within the walls of the rear housing). The channels 332a are formed along or around the rear housing portion 322 and thus may be at or near a circuit board or cooling element of the camera or circuit board or circuitry to draw heat away from the circuit board when the fluid is flowing through and thus cooling the channels. The channels then interface with corresponding channels 324a of the front housing or lens holder 324. The fluid is passed through the front housing 324 in the same manner. The fluid then exits the channels 324a of the lens holder 324 through ports 324b, which direct the fluid in a spray onto the lens (not shown in FIG. 15) to clean dirt or debris from the lens.

The channels may be formed during injection molding of the housing portions and may be formed so that the fluid passes within the walls or structure of the housing portions at or near the circuit board or circuit element or at or near a thermally conductive element that contacts and connects between the circuit board and the wall or structure of the housing portion (such as by utilizing aspects of the camera systems described in U.S. publication No. US-2015-0327398, which is hereby incorporated herein by reference in its entirety).

The electrical circuit of the camera may include a temperature monitoring circuit. Using this circuit along with software, the camera may communicate a signal via a communication link to the vehicle to activate the washer nozzle system (such as responsive to a determined temperature at the camera being above a threshold temperature level). By activating the washer nozzle system via a control circuit and thereby passing fluid through the fluid channels and around the camera, the fluid would draw heat from the camera to reduce the camera temperature. Thus, the operating temperature of the electrical components on the circuit board(s) inside the camera would be lowered via heat transfer when the pressurized fluid system is activated.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in International Publication Nos. WO 2013/081984 and/or WO 2013/081985, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an EyeQ2 or EyeQ3 image processing chip available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ladar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. Preferably, the imaging array has at least 300,000 photosensor elements or pixels, more preferably at least 500,000 photosensor elements or pixels and more preferably at least 1 million photosensor elements or pixels. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, which are all hereby incorporated herein by reference in their entireties. The system may communicate with other communication systems via any suitable means, such as by utilizing aspects of the systems described in International Publication Nos. WO/2010/144900; WO 2013/043661 and/or WO 2013/081985, and/or U.S. Publication No. US-2012-0062743, which are hereby incorporated herein by reference in their entireties.

The imaging device and control and image processor and any associated illumination source, if applicable, may comprise any suitable components, and may utilize aspects of the cameras and vision systems described in U.S. Pat. Nos. 5,550,677; 5,877,897; 6,498,620; 5,670,935; 5,796,094; 6,396,397; 6,806,452; 6,690,268; 7,005,974; 7,937,667; 7,123,168; 7,004,606; 6,946,978; 7,038,577; 6,353,392; 6,320,176; 6,313,454 and/or 6,824,281, and/or International Publication Nos. WO 2010/099416; WO 2011/028686 and/or WO 2013/016409, which are all hereby incorporated herein by reference in their entireties. The camera or cameras may comprise any suitable cameras or imaging sensors or camera modules, and may utilize aspects of the cameras or sensors described in U.S. Publication No. US-2009-0244361 and/or U.S. Pat. Nos. 8,542,451; 7,965,336 and/or 7,480,149, which are hereby incorporated herein by reference in their entireties. The imaging array sensor may comprise any suitable sensor, and may utilize various imaging sensors or imaging array sensors or cameras or the like, such as a CMOS imaging array sensor, a CCD sensor or other sensors or the like, such as the types described in U.S. Pat. Nos. 5,550,677; 5,670,935; 5,760,962; 5,715,093; 5,877,897; 6,922,292; 6,757,109; 6,717,610; 6,590,719; 6,201,642; 6,498,620; 5,796,094; 6,097,023; 6,320,176; 6,559,435; 6,831,261; 6,806,452; 6,396,397; 6,822,563; 6,946,978; 7,339,149; 7,038,577; 7,004,606; 7,720,580 and/or 7,965,336, and/or International Publication Nos. WO/2009/036176 and/or WO/2009/046268, which are all hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vision system of a vehicle, said vision system comprising:
a camera configured to be disposed at an exterior portion of a vehicle so as to have a field of view exterior of the vehicle, said camera having a lens; and
a washer comprising a connector and fluid passageway, wherein said washer is configured to be detachably attached at said camera when said camera is disposed at the exterior portion of the vehicle, and wherein, when attached at said camera, said connector is configured for connection to a washer system of a vehicle such that, when the vehicle washer system is actuated, pressurized fluid flows through said fluid passageway and onto said lens.

2. The vision system of claim 1, wherein said camera is configured to be fixedly mounted at the exterior portion of the vehicle.

3. The vision system of claim 2, wherein, with said camera mounted at the exterior portion of the vehicle, said lens is exposed at the exterior portion of the vehicle.

4. The vision system of claim 1, wherein an outlet is formed at said washer at an end of said fluid passageway and wherein, when said washer is attached at said camera, said outlet is disposed at or near an exterior surface of said lens.

5. The vision system of claim 4, wherein said outlet is configured to spray pressurized fluid onto the exterior surface of said lens.

6. The vision system of claim 1, wherein said connector and said fluid passageway are integrally formed via injection molding.

7. The vision system of claim 1, wherein said washer comprises a clip element that is configured to snap attach at a housing portion of said camera to detachably attach said washer at said camera.

8. The vision system of claim 7, wherein said washer comprises a tab that is configured to engage said housing portion to retain said washer at said camera.

9. The vision system of claim 1, wherein said washer comprises a washer body comprising said fluid channel and said connector.

10. The vision system of claim 9, wherein said washer comprises a cover element that is detachably attached at said washer body so that an inner portion of said cover element is in said fluid channel.

11. The vision system of claim 10, wherein said inner portion of said cover element comprises a molded-in pressure channel that is configured to provide a selected flow characteristics to the fluid flowing through said fluid channel.

12. The vision system of claim 11, wherein said washer comprises a valve disposed in said fluid channel to limit back flow of fluid when pressure is not applied.

13. The vision system of claim 1, comprising a temperature sensor for sensing a temperature at said camera, wherein, responsive to an output of said temperature sensor that is indicative of the temperature at said camera being above a threshold level, a control operates the washer system of the vehicle to flow fluid through at least one fluid channel of said camera to reduce the temperature of said camera.

14. A vision system of a vehicle, said vision system comprising:
a camera configured to be disposed at an exterior portion of a vehicle so as to have a field of view exterior of the vehicle, said camera having a housing portion and a lens barrel that includes a lens;
a washer body comprising a connector and fluid passageway, wherein said washer body is configured to snap attach at said lens barrel and wherein said washer body, when snap attached at said lens barrel, has a nozzle end of said washer body disposed at and directed towards an outer surface of said lens;
wherein said washer body includes a spring tab that engages a rear surface of said housing portion when said washer body is snap attached at said lens barrel, said spring tab positioning said washer body and said nozzle end at a selected position relative to said outer surface of said lens; and
wherein said connector is configured for connection to a washer system of a vehicle such that, when the vehicle washer system is actuated, pressurized fluid flows through said fluid passageway and through said nozzle end and onto said outer surface of said lens.

15. The vision system of claim 14, wherein said washer body comprise a partial ring connector that snap attaches at said lens barrel, and wherein said partial ring connector includes tabs that engage respective tabs at said lens barrel to limit rotation of said washer body about said lens barrel when said partial ring connector is snap attached at said lens barrel.

16. The vision system of claim 14, wherein said washer body comprises a nozzle chip disposed at said nozzle end to establish a selected spray pattern of said nozzle end.

17. The vision system of claim 14, wherein said washer comprises a cover element that is detachably attached at said washer body so that an inner portion of said cover element is in said fluid channel, and wherein said inner portion of said cover element comprises a molded-in pressure channel that is configured to provide a selected flow characteristics to the fluid flowing through said fluid channel.

18. The vision system of claim 14, wherein said washer comprises a valve disposed in said fluid channel to limit back flow of fluid when pressure is not applied.

19. A vision system of a vehicle, said vision system comprising:
a camera configured to be disposed at an exterior portion of a vehicle so as to have a field of view exterior of the vehicle, said camera having a housing portion and a lens;
wherein said housing portion includes a washer comprising a connector and fluid passageway, wherein, when said camera is disposed at the exterior portion of the vehicle, said connector is configured for connection to a washer system of the vehicle such that, when the vehicle washer system is actuated, pressurized fluid flows through said fluid passageway and onto said lens; and
wherein an outlet is formed at said washer at an end of said fluid passageway and wherein, when said washer is attached at said camera, said outlet is disposed at or near an exterior surface of said lens, and wherein said outlet is configured to spray pressurized fluid onto the exterior surface of said lens.

20. The vision system of claim 19, wherein said housing portion and connector and said fluid passageway are integrally formed via injection molding.

21. The vision system of claim 19, wherein said washer comprises a cover element that is detachably attached at said housing portion so that an inner portion of said cover element is in said fluid channel.

22. The vision system of claim 21, wherein said inner portion of said cover element comprises a molded-in pressure channel that is configured to provide a selected flow characteristics to the fluid flowing through said fluid channel.

23. The vision system of claim 19, wherein said washer comprises a valve disposed in said fluid channel to limit back flow of fluid when pressure is not applied.

24. The vision system of claim 19, comprising a temperature sensor for sensing a temperature at said camera, wherein, responsive to an output of said temperature sensor that is indicative of the temperature at said camera being above a threshold level, a control operates the washer system of the vehicle to flow fluid through at least one fluid channel of said camera to reduce the temperature of said camera.
